(19) United States
(12) Patent Application Publication
(10) Pub. No.: US 2024/0251725 A1
(43) Pub. Date: Aug. 1, 2024

(54) APPARATUS FOR STERILIZING NUTRIENT SOLUTION, AND MEDIUM CULTIVATION SYSTEM USING SAME

(71) Applicant: PURE PLATECH CO., LTD., Hwaseong-si, Gyeonggi-do (KR)

(72) Inventors: Kyoung Doo KANG, Seongnam-si, Gyeonggi-do (KR); Kyoung Jun KO, Hwaseong-si, Gyeonggi-do (KR); Min Jae KIM, Suwon-si, Gyeonggi-do (KR); Seon Mi LEE, Pocheon-si, Gyeonggi-do (KR); Dae Ryong JI, Hwaseong-si, Gyeonggi-do (KR)

(73) Assignee: PURE PLATECH CO., LTD., Hwaseong-si, Gyeonggi-do (KR)

(21) Appl. No.: 18/289,371

(22) PCT Filed: Aug. 4, 2021
(86) PCT No.: PCT/KR2021/010262

§ 371 Date: Nov. 3, 2023

(30) Foreign Application Priority Data
May 7, 2021 (KR) 10-2021-0059191

(51) Int. Cl. A01G 31/02; A01G 31/00

(52) U.S. Cl. CPC A01G 31/02; A01G 2031/006

(57) ABSTRACT

The present invention relates to a medium cultivation system including: a cultivation bed in which plants are placed and which allows the plants to be cultivated by means of a nutrient solution; a nutrient solution tank in which the nutrient solution to be supplied to the cultivation bed is stored; and an apparatus for sterilizing a nutrient solution which sterilizes waste nutrient solution, discharged from the cultivation bed, for reuse or disposal or sterilizes the nutrient solution stored in the nutrient solution tank for supply to the cultivation bed, wherein the apparatus for sterilizing the nutrient solution is provided with a sterilizing unit, which sterilizes the nutrient solution to be sterilized, by supplying a sterilizing gas in the form of bubbles to the nutrient solution to be dissolved therein, and a sterilizing gas generator, which generates the sterilizing gas.

### TECHNICAL FIELD

The present invention relates to medium cultivation technology using a nutrient solution, and more particularly, to technology for sterilizing a nutrient solution used in medium cultivation.

### BACKGROUND ART

In general, medium cultivation is an agricultural method in which land plants are grown using water with a nutrient solution (nutrient medium) without soil, and the nutrient solution is supplied directly to the plant roots or soaked in an inert support that acts as a root support. Compared to absorbing nutrients through the soil, when nutrients are supplied through the nutrient solution, plants absorb nutrients much more efficiently, so that the effects of promoting growth are obtained. By using this medium cultivation method, the growth environment of plants can be controlled in detail so that it is possible to not only increase production but also control harvest time. Also, it enables crop production in areas where soil quality has deteriorated or where it is difficult to grow crops.

Korean Patent Laid-open Publication No. 10-2012-0024352, which is a prior patent document related to the present invention, discloses a configuration for reusing a nutrient solution by sterilizing microorganisms contained in waste water discharged from a cultivation medium by using an ultraviolet lamp.

### DETAILED DESCRIPTION OF THE INVENTION

### Technical Problem

The present invention provides an apparatus for sterilizing a nutrient solution and a medium cultivation system using the apparatus.

The present invention also provides an apparatus for sterilizing a nutrient solution in which a waste nutrient solution is efficiently sterilized before being disposed.

The present invention also provides an apparatus for sterilizing a nutrient solution in which a waste nutrient solution is efficiently sterilized so as to be reused.

The present invention also provides an apparatus for sterilizing a nutrient solution in which a nutrient solution is efficiently sterilized before being supplied for cultivation.

### Technical Solution

According to an aspect of the present invention, there is provided an apparatus for sterilizing a nutrient solution to be treated, the apparatus including: a sterilizing unit, which sterilizes the nutrient solution to be sterilized, by supplying a sterilizing gas in the form of bubbles to the nutrient solution to be dissolved therein; and a sterilizing gas generator, which generates the sterilizing gas.

According to another embodiment of the present invention, there is provided a medium cultivation system including: a cultivation bed in which plants are placed and which allows the plants to be cultivated by means of a nutrient solution; a nutrient solution tank in which the nutrient solution to be supplied to the cultivation bed is stored; and an apparatus for sterilizing a nutrient solution which sterilizes waste nutrient solution, discharged from the cultivation bed, for reuse or disposal or sterilizes the nutrient solution stored in the nutrient solution tank for supply to the cultivation bed, wherein the apparatus for sterilizing the nutrient solution is provided with a sterilizing unit, which sterilizes the nutrient solution to be sterilized, by supplying a sterilizing gas in the form of bubbles to the nutrient solution to be dissolved therein, and a sterilizing gas generator, which generates the sterilizing gas.

### Effects of the Invention

According to the present invention, all of the objectives of the present invention described above can be achieved. Specifically, since a nutrient solution to be treated is sterilized, by supplying a sterilizing gas in the form of bubbles to the nutrient solution to be dissolved therein, the efficiency of sterilization of the nutrient solution is enhanced.

### DESCRIPTION OF THE DRAWINGS

FIG. 1 is a view schematically illustrating a configuration of a medium cultivation system according to an embodiment of the present invention.

FIG. 2 is a view schematically illustrating a configuration of an apparatus for sterilizing a nutrient solution in the medium cultivation system shown in FIG. 1.

FIG. 3 is a cross-sectional view illustrating the inside of a first sterilizing tank in the apparatus for sterilizing the nutrient solution shown in FIG. 2.

FIG. 4 is a cross-sectional view illustrating the inside of a second sterilizing tank in the apparatus for sterilizing the nutrient solution shown in FIG. 2.

FIG. 5 is a perspective view of a waste nutrient solution supply unit shown in FIG. 4.

FIG. 6 is a perspective view illustrating the waste nutrient solution supply unit shown in FIG. 5, according to another embodiment.

FIG. 7 is a view schematically illustrating a configuration of a medium cultivation system according to another embodiment of the present invention.

FIG. 8 is a view schematically illustrating the apparatus for sterilizing the nutrient solution shown in FIG. 2, according to another embodiment.

FIG. 9 is a cross-sectional view illustrating the inside of a sterilizing tank shown in FIG. 8.

FIG. 10 is a perspective view of a bubble reduction unit shown in FIG. 8.

FIG. 11 is a perspective view illustrating the bubble reduction unit shown in FIG. 10, according to another embodiment.

FIG. 12 is a cross-sectional view illustrating the bubble reduction unit shown in FIG. 10, according to another embodiment.

### MODE OF THE INVENTION

Hereinafter, the configuration and operation of the present invention will be described in detail by describing embodiments of the present invention with reference to the accompanying drawings.

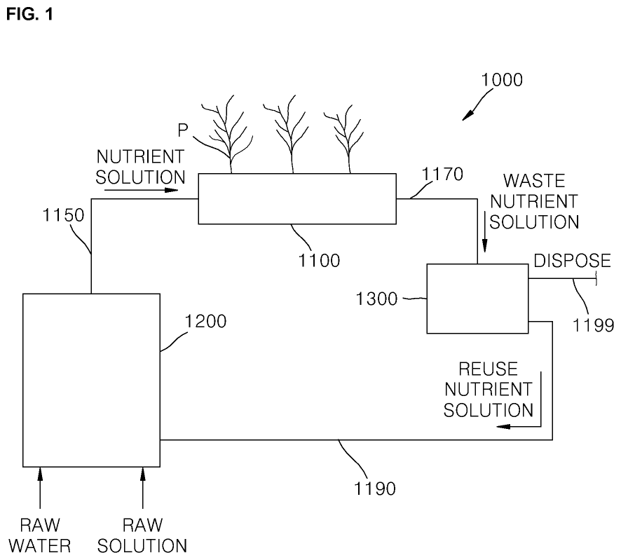

FIG. 1 illustrates a schematic configuration of a medium cultivation system according to an embodiment of the present invention. Referring to FIG. 1, a medium cultivation system 1000 according to an embodiment of the present invention includes a cultivation bed 1100 in which plants P to be cultivated are placed and which allows the plants to be cultivated by using a nutrient solution supplied to the cultivation bed 1100, a nutrient solution tank 1200 in which the nutrient solution supplied to the cultivation bed 1100 is stored, and an apparatus 1300 for sterilizing a nutrient solution so as to reuse or dispose a waste nutrient solution discharged from the cultivation bed 1100.

The cultivation bed 1100 that is a configuration generally used in medium cultivation using the nutrient solution includes a water tank in which the nutrient solution is accommodated, and a medium unit which absorbs the nutrient solution in the water tank and supports plants P to be cultivated. The nutrient solution is supplied to the cultivation bed 1100 from the nutrient solution tank 1200 through a nutrient solution supply pie 1150. The waste nutrient solution discharged from the cultivation bed 1100 is supplied to the apparatus 1300 for sterilizing the nutrient solution through a waste nutrient solution discharge pipe 1170.

The nutrient solution is stored in the nutrient solution tank 1200, and the nutrient solution stored in the nutrient solution tank 1200 is supplied to the cultivation bed 1100 through the nutrient solution supply pipe 1150. The nutrient solution stored in the nutrient solution tank 1200 is made by mixing raw water, a raw solution for the nutrient solution and a reuse nutrient solution discharged from the apparatus 1300 for sterilizing the nutrient solution.

The apparatus 1300 for sterilizing the nutrient solution sterilizes the waste nutrient solution discharged from the cultivation bed 1100 for reuse. The apparatus 1300 for sterilizing the nutrient solution receives the waste nutrient solution discharged from the cultivation bed 1100 through the waste nutrient solution discharge pipe 1170. The reuse nutrient solution discharged from the apparatus 1300 for sterilizing the nutrient solution is supplied to the nutrient solution tank 1200 through a nutrient solution circulation pipe 1190.

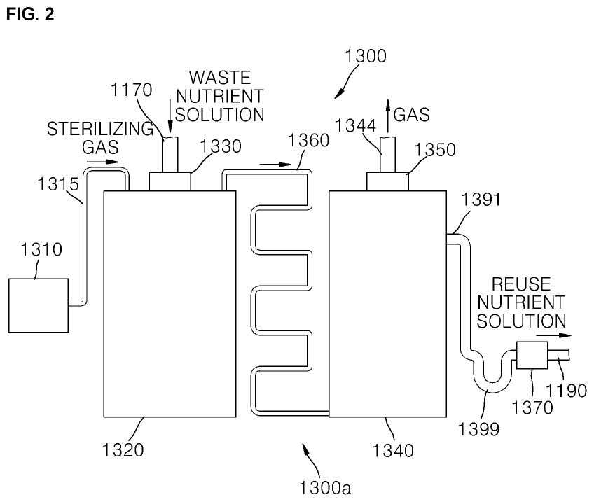

Referring to FIGS. 2 through 4 that are drawings of the apparatus 1300 for sterilizing the nutrient solution, the apparatus 1300 for sterilizing the nutrient solution includes a sterilizing gas generator 1310 that generates a sterilizing gas, a sterilizing unit 1300a that sterilizes the waste nutrient solution to be sterilized, discharged from the cultivation bed 1100, by using a sterilizing gas, and a nutrient solution discharge pump 1370 through which the waste nutrient solution sterilized by the sterilizing unit 1300a is discharged as a reuse nutrient solution.

The sterilizing gas generator 1310 generates the sterilizing gas used in sterilizing of the waste nutrient solution to be sterilized. The sterilizing gas generated in the sterilizing gas generator 1310 may be ozone (O₃), chlorine dioxide (ClO₂), hydroxide ion (OH⁻) or an excited oxygen atom (O*), which are gases with sterilizing power. The sterilizing gas generator 1310 may be a common configuration that can generate a sterilizing gas, such as a plasma reactor and thus, detailed descriptions thereof are omitted. The sterilizing gas generated in the sterilizing gas generator 1310 is supplied to the sterilizing unit 1300a through a sterilizing gas supply pipe 1315.

The sterilizing unit 1300a sterilizes the waste nutrient solution to be sterilized, discharged from the cultivation bed 1100, by using the sterilizing gas generated in the sterilizing gas generator 1310. The sterilizing unit 1300a includes a first sterilization treatment unit 1320 that performs primary sterilization treatment on the waste nutrient solution to be sterilized, a pre-treatment filter 1330 that pre-treats the waste nutrient solution to be treated, introduced into the first sterilization treatment unit 1320, a second sterilization treatment unit 1340 that performs secondary sterilization treatment on the primarily-treated waste nutrient solution, discharged from the first sterilization treatment unit 1320, a gas treatment filter 1350 that treats a gas discharged from the second sterilization treatment unit 1340, a connection pipe 1360 that allows the first sterilization treatment unit 1320 and the second sterilization treatment unit 1340 to communicate with each other, and a treatment nutrient solution discharge pipe 1391 that extends from the second sterilization treatment unit 1340 and is connected to the nutrient solution discharge pump 1370.

The first sterilization treatment unit 1320 performs primary sterilization treatment on the waste nutrient solution to be sterilized, discharged from the cultivation bed 1100 through the waste nutrient solution discharge pipe 1170. The first sterilization treatment unit 1320 includes a first sterilizing tank 1321 in which the waste nutrient solution to be sterilized is stored, a nozzle 1323 that supplies the sterilizing gas in the form of bubbles B within the first sterilizing unit 1321, and a waste nutrient solution supply pipe 1325 that supplies the waste nutrient solution to be sterilized within the first sterilizing tank 1321.

The first sterilizing tank 1321 provides a first sterilization treatment space 1322 sealed therein. The first sterilization treatment space 1322 is fully filled with the waste nutrient solution to be sterilized, discharged from the waste nutrient solution supply pipe 1325. The nozzle 1323 and the waste nutrient solution supply pipe 1325 are placed in the first sterilization treatment space 1322. A waste nutrient solution L1 to be sterilized, fully filled in the first sterilization treatment space 1322, is sterilized by the sterilizing gas in the form of bubbles B supplied from the nozzle 1323. A primarily-treated waste nutrient solution outlet 1324 is formed on the ceiling of the first sterilization treatment space 1322. The primarily-treated waste nutrient solution outlet 1324 is connected to the connection pipe 1360 so that the waste nutrient solution L1 stored in the first sterilization treatment space 1322 is discharged to the outside.

The nozzle 1323 is placed adjacent to the bottom in the first sterilization treatment space 1322 and supplies the sterilizing gas in the form of bubbles B to the waste nutrient solution L1 to be sterilized, filled in the first sterilization treatment space 1322. The sterilizing gas in the form of bubbles B supplied to the waste nutrient solution L1 to be sterilized, in the first sterilization treatment space 1322, are dissolved in the waste nutrient solution to be sterilized, and the waste nutrient solution L1 to be sterilized is sterilized. Preferably, the nozzle 1323 supplies the sterilizing gas in the form of fine bubbles B of micro or nanobubbles so that the sterilizing gas in the form of bubbles B can be well dissolved in the waste nutrient solution L1 to be sterilized. The nozzle 1323 is connected to the sterilizing gas generator 1310 through the sterilizing gas supply pipe 1315.

The waste nutrient solution supply pipe 1325 is placed in the first sterilization treatment space 1322 and supplies the waste nutrient solution to be sterilized, to the first sterilization treatment space 1322. The waste nutrient solution supply pipe 1325 extends from the ceiling of the first sterilization treatment space 1322 downwards. The upper end of the waste nutrient solution supply pipe 1325 communicates with the waste nutrient solution discharge pipe 1170 with the pre-treatment filter 1330 therebetween. One or a plurality of waste nutrient solution outlets 1327 that discharge the waste nutrient solution to be sterilized, supplied through the waste nutrient solution discharge pipe 1170, into the first sterilization treatment space 1322 are formed on a lower side of the waste nutrient solution supply pipe 1325. The waste nutrient solution outlet 1327 is formed on the side of the waste nutrient solution supply pipe 1325 so that the sterilizing gas in the form bubbles B can be prevented from being introduced into the waste nutrient solution supply pipe 1325 through the waste nutrient solution outlet 1327. Unlike this, the end of the waste nutrient solution supply pipe 1325 is formed upwards, and a nutrient solution discharge pipe is formed at the end of the waste nutrient solution supply pipe 1325 so that the sterilizing gas in the form of bubbles B can be prevented from being introduced into the waste nutrient solution supply pipe 1325, and this also belongs to the scope of the present invention.

The waste nutrient solution L1, which is stored in the first sterilization treatment space 1322 and primarily sterilized, is discharged through the connection pipe 1360 and is supplied to the second sterilization treatment unit 1340.

The pre-treatment filter 1330 is installed between the waste nutrient solution discharge pipe 1170 and the waste nutrient solution supply pipe 1325 and allows the waste nutrient solution discharge pipe 1170 and the waste nutrient solution supply pipe 1325 to communicate with each other. The pre-treatment filter 1330 filters foreign substances from the waste nutrient solution introduced into the waste nutrient solution supply pipe 1325 from the waste nutrient solution discharge pipe 1170, thereby performing pre-treatment.

The second sterilization treatment unit 1340 performs secondary sterilization treatment on the primarily-treated waste nutrient solution discharged from the first sterilization treatment unit 1320. The second sterilization treatment unit 1340 includes a second sterilizing tank 1341 in which the waste nutrient solution to be sterilized is stored, and a waste nutrient solution supply unit 1345 that supplies the waste nutrient solution to be sterilized, within the second sterilizing tank 1341.

The second sterilizing tank 1341 provides a second sterilization treatment space 1342 sealed therein. The waste nutrient solution to be sterilized, discharged from the waste nutrient solution supply unit 1345, with a set water level S is stored in the second sterilization treatment space 1342. A secondarily-treated waste solution outlet 1349, which is placed higher than the waste nutrient solution supply unit 1345 and through which the secondarily-sterilized waste nutrient solution L2 in the second sterilization treatment space 1342 is discharged to the outside, is formed on an upper part of a side of the second sterilization treatment space 1342. The water level S of the waste nutrient solution L2 to be sterilized, stored in the second sterilization treatment space 1342, is maintained to be lower than the ceiling of the second sterilization treatment space 1342 and to be higher than the secondarily-treated waste nutrient solution outlet 1349. The waste nutrient solution L2 to be sterilized, stored in the second sterilization treatment space 1342, is sterilized by the sterilizing gas in the form of bubbles B discharged together with the waste nutrient solution to be sterilized, discharged from the waste nutrient solution supply unit 1345. A gas outlet 1343 through which gas is discharged to the outside from the second sterilization treatment space 1342, is formed on the ceiling of the second sterilizing tank 1341. A gas discharge pipe 1344 is connected to the gas outlet 1343.

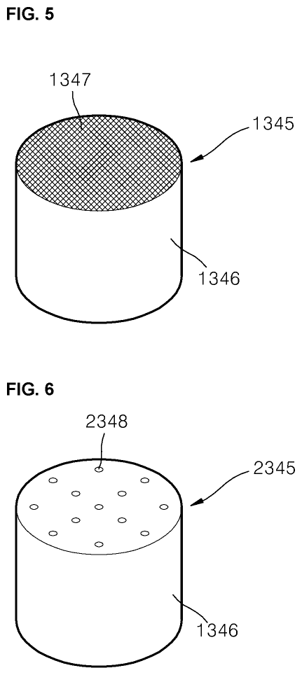

The waste nutrient solution supply unit 1345 is placed adjacent to the bottom in the second sterilization treatment space 1342 and discharges and supplies the waste nutrient solution to be sterilized, into the second sterilization treatment space 1342. The waste nutrient solution supply unit 1345 is connected to the connection pipe 1360 and supplies the waste nutrient solution discharged from the first sterilizing tank 1321 to the second sterilization treatment space 1342. The waste nutrient solution supply unit 1345 discharges the sterilizing gas in the form of bubbles B, which are not dissolved in the waste nutrient solution to be sterilized, together with the waste nutrient solution to be sterilized, into the second sterilization treatment space 1342. Referring to FIG. 5 that shows the waste nutrient solution supply unit 1345, the waste nutrient solution supply unit 1345 includes a body portion 1346, and a discharge portion 1347 coupled to the body portion 1346.

The body portion 1346 provides an inner space, and a lower portion and a side of the body portion 1346 are closed, and at least a part of an upper end of the body portion 1346 is open so that an opening can be formed in the upper end of the body portion 1346. The connection pipe 1360 communicates with the body portion 1346 so that the waste nutrient solution to be sterilized, can be introduced into the inner space of the body portion 1346 through the connection pipe 1360. A discharge portion 1347 is coupled to the opening formed in the upper end of the body portion 1346.

The discharge portion 1347 is a mesh coupled to the opening formed in the upper end of the body portion 1346. The waste nutrient solution to be sterilized and the sterilizing gas in the form of bubbles B are discharged into the second sterilization treatment space 1342 through the discharge portion 1347. Part of the sterilizing gas in the form of bubbles B that are not dissolved in the waste nutrient solution L1 in the first sterilization treatment space 1322 is clumped while rising and has an increased size, but while part of the sterilizing gas in the form of bubbles B that are not dissolved in the waste nutrient solution L1 passes through the discharge portion 1347 in the second sterilization treatment unit 1340, part of the sterilizing gas in the form of bubbles B that are not dissolved in the waste nutrient solution L1 is broken by the mesh and has a reduced size and thus can be well dissolved in the waste nutrient solution L2 to be sterilized, stored in the second sterilization treatment space 1342.

In the embodiment of FIG. 5, the discharge portion 1347 is a mesh. However, unlike this, as shown in FIG. 6, a discharge portion 2347 may be a plate having a plurality of fine holes 2348 formed therein. The discharge portion 2347 may discharge the sterilizing gas in the form of bubbles B by reducing the size of the sterilizing gas in the form of bubbles B, as in the discharge portion 1346 shown in FIG. 6.

In the embodiments of FIGS. 5 and 6, the entire sides of the body portion 1346 are closed, but unlike this, the mesh that is the discharge portion 1347 of FIG. 5 or the fine holes 2348 of FIG. 6 may be formed in at least part of the side of the body portion 1346, and this also belongs to the scope of the present invention.

The waste nutrient solution L2, which is stored in the second sterilization treatment space 1342 and secondarily sterilized, is discharged through a treatment nutrient solution discharge pipe 1391 and is supplied to the nutrient solution tank 1200 via the nutrient solution circulation pipe 1190 by means of an operation of the nutrient solution discharge pump 1370.

The gas treatment filter 1350 is installed on the gas discharge pipe 1344. The gas treatment filter 1350 treats harmful gas components such as ozone (O₃) or chlorine dioxide (ClO₂) included in gas, which is not dissolved and discharged to the outside from the second sterilization treatment space 1342 through the gas discharge pipe 1344. A common configuration for treating harmful gas components may be used as the gas treatment filter 1350, and detailed descriptions thereof are omitted.

The connection pipe 1360 allows the first sterilization treatment unit 1320 and the second sterilization treatment unit 1340 to communicate with each other. Both ends of the connection pipe 1360 are coupled to the primarily-treated waste nutrient solution outlet 1324 formed in the first sterilizing tank 1321 and the body portion 1346 of the waste nutrient solution supply unit 1345, respectively. The waste nutrient solution L1, which is stored in the first sterilization treatment space 1321 and primarily sterilized, is supplied to the second sterilization treatment space 1342 through the connection pipe 1360. Preferably, the connection pipe 1360 extends in a zigzag form to form a long flow path, as shown in FIG. 2. This is to increase time at which the sterilizing gas in the form of bubbles B can be dissolved while the waste nutrient solution flows along the connection pipe 1360. The water level S of the second sterilization treatment space 1341 is formed to be lower than the water level of the first sterilization treatment space 1321 so that the waste nutrient solution L stored in the first sterilization treatment space 1321 may flow into the second sterilization treatment space 1342 through the connection pipe 1360 without external power.

The treatment nutrient solution discharge pipe 1391 extends from the secondarily-treated waste nutrient solution outlet 1349 formed in the second sterilizing tank 1341 and is connected to the nutrient solution discharge pump 1370. The treatment nutrient solution discharge pipe 1391 includes a U-shaped pipe portion 1399 located adjacent to the nutrient solution discharge pump 1370. Even when the nutrient solution discharge pump 1370 does not operate, a harmful gas is prevented from passing through the nutrient solution discharge pump 1370 and being discharged through the nutrient solution circulation pipe 1190 by means of the nutrient solution remaining in the U-shaped pipe portion 1399.

The nutrient solution discharge pump 1370 discharges the waste nutrient solution sterilized by the sterilizing unit 1300a as a reuse nutrient solution. The nutrient solution discharge pump 1370 is installed between the treatment nutrient solution discharge pipe 1391 and the nutrient solution circulation pipe 1190 and supplies the sterilized waste nutrient solution discharged from the sterilizing unit 1300a as the reuse nutrient solution to the nutrient solution tank 1200. The sterilized waste nutrient solution discharged through the nutrient solution discharge pump 1370 may be discharged not to be supplied to the nutrient solution tank 1200 but to be disposed through a disposal line (1199 of FIG. 1).

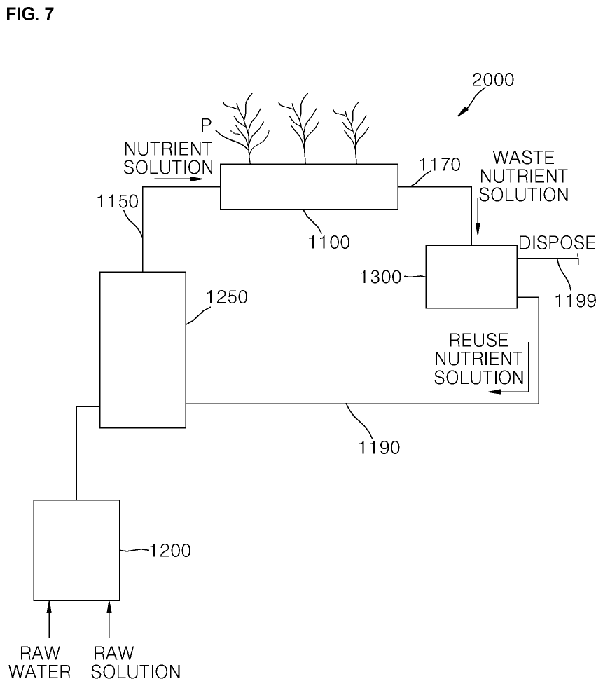

FIG. 7 illustrates a schematic configuration of a medium cultivation system according to another embodiment of the present invention. Referring to FIG. 7, it will be understood that the medium cultivation system 2000 according to another embodiment of the present invention further includes a nutrient solution addition mixing tank 1250 in the medium cultivation system 1000 shown in FIG. 1. A nutrient solution raw material in which raw water and a raw solution for the nutrient solution are mixed with each other, is stored in the nutrient solution tank 1200. The nutrient solution addition mixing tank 1250 mixes the nutrient solution raw material supplied from the nutrient solution tank 1200 and the reuse nutrient solution supplied from the apparatus 1300 for sterilizing the nutrient solution with each other to store a mixture as a mixed nutrient solution. The mixed nutrient solution stored in the nutrient solution addition mixing tank 1250 is supplied to the cultivation bed 1100.

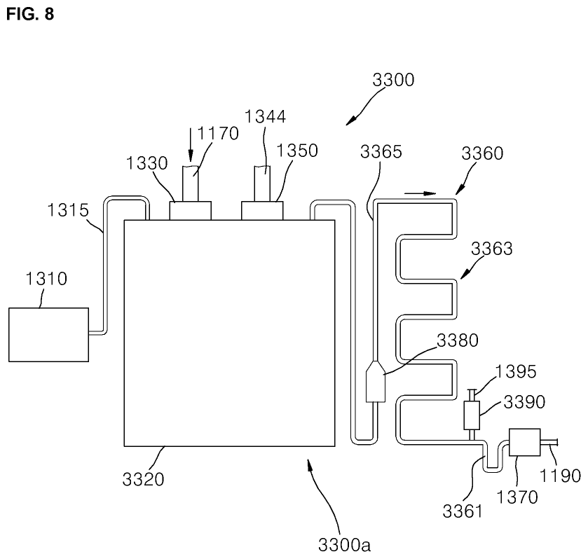

FIG. 8 illustrates a configuration of an apparatus 3300 for sterilizing the nutrient solution according to another embodiment of the present invention. The apparatus 3300 for sterilizing the nutrient solution according to another embodiment of the present invention shown in FIG. 8 may be used in the system shown in FIGS. 1 and 7 by replacing the apparatus 1300 for sterilizing the nutrient solution shown in FIG. 2. Referring to FIG. 8, the apparatus 3300 for sterilizing the nutrient solution according to another embodiment of the present invention includes a sterilizing gas generator 1310 that generates a sterilizing gas, a sterilizing unit 3300a that sterilizes the waste nutrient solution to be sterilized, discharged from the cultivation bed (1100 of FIGS. 1 and 7), by using the sterilizing gas, and a nutrient solution discharge pump 1370 that discharges the waste nutrient solution sterilized by the sterilizing unit 3300a as a reuse nutrient solution.

The sterilizing gas generator 1310 generates a sterilizing gas used in sterilization of the waste nutrient solution to be sterilized. The configuration and operation of the sterilizing gas generator 1310 are the same as those of the sterilizing gas generator 1310 according to the embodiment shown in FIG. 2 and thus, detailed descriptions thereof are omitted. The sterilizing gas generated by the sterilizing gas generator 1310 is supplied to the sterilizing unit 3300a through the sterilizing gas supply pipe 1315.

The sterilizing unit 3300a sterilizes the waste nutrient solution to be sterilized, discharged from the cultivation bed (1100 of FIGS. 1 and 7), by using the sterilizing gas generated in the sterilizing gas generator 1310. The sterilizing unit 3300a includes a sterilization treatment unit 3320 that performs sterilization treatment on the waste nutrient solution, a pre-treatment filter 1330 that pre-treats the waste nutrient solution to be treated, introduced into the sterilization treatment unit 3320, a first gas treatment filter 1350 that treats gas discharged from the sterilization treatment unit 3320, a connection pipe 3360 that extends from the sterilization treatment unit 3320 and is connected to the nutrient solution discharge pump 1370, a bubble reduction unit 3380 installed on the connection pipe 3360, and a second gas treatment filter 3390 that is installed on the connection pipe 3360 and treats the gas discharged from the connection pipe 3360.

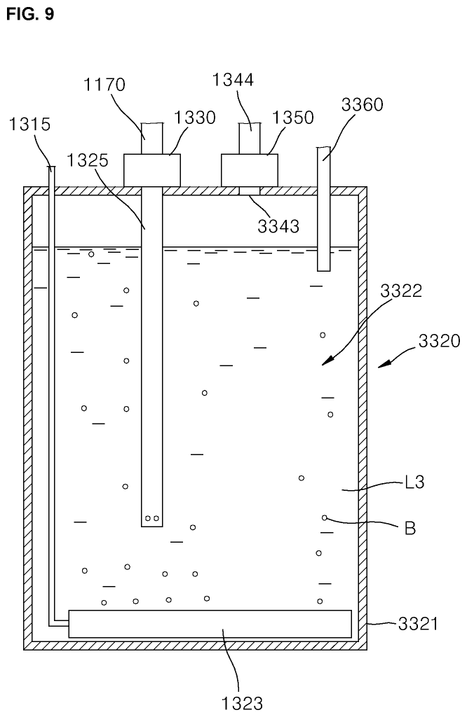

Referring to FIGS. 8 and 9, the sterilization treatment unit 3320 performs sterilization treatment on the waste nutrient solution to be sterilized, discharged from the cultivation bed (1100 of FIGS. 1 and 7) through the waste nutrient solution discharge pipe 1170. The sterilization treatment unit 3320 includes a sterilizing tank 3321 in which the waste nutrient solution to be sterilized is stored, a nozzle that supplies the sterilizing gas in the form of the bubbles B within the sterilizing tank 3321, and a waste nutrient solution supply pipe 1325 that supplies the waste nutrient solution to be sterilized within the sterilizing tank 3321.

The sterilizing tank 3321 provides a sterilization treatment space 1322 sealed therein. The waste nutrient solution to be sterilized, discharged from the waste nutrient solution supply pipe 1325, with a certain water level is stored in the sterilization treatment space 3322. The nozzle 1323 and the waste nutrient solution supply pipe 1325 are placed in the sterilization treatment space 3322. A waste nutrient solution L3 to be sterilized, stored in the sterilization treatment space 3322 at a certain water level, is sterilized by the sterilizing gas in the form of bubbles B supplied from the nozzle 1323. A gas outlet 3343 through which gas is discharged from the sterilization treatment space 3342 to the outside, is formed on the ceiling of the sterilization treatment space 3322. A gas discharge pipe 1344 is connected to the gas outlet 3343. One end of the connection pipe 3360 is placed in the sterilization treatment space 3322. The waste nutrient solution L3 stored in the sterilization treatment space 3322 is discharged to the outside through the connection pipe 3360.

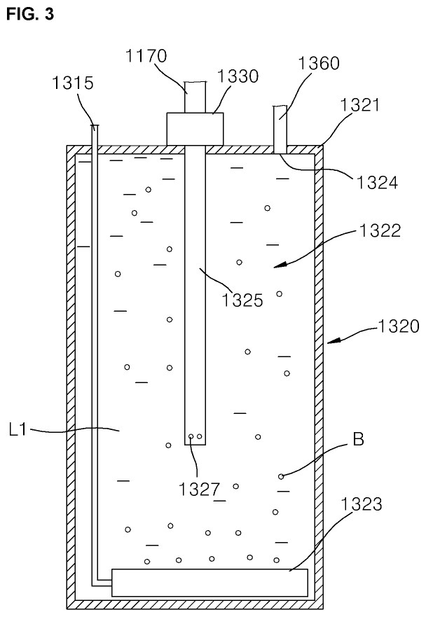

The nozzle 1323 is placed adjacent to the bottom in the sterilization treatment space 3322 and supplies the sterilizing gas in the form of bubbles B to the waste nutrient solution L3 to be sterilized, stored in the sterilization treatment space 1322. The sterilizing gas in the form of bubbles B supplied to the waste nutrient solution L3 to be sterilized, in the sterilization treatment space 3322, are dissolved in the waste nutrient solution L3 to be sterilized, and the waste nutrient solution L3 to be sterilized is sterilized. The detailed configuration and operation of the nozzle 1323 are the same as those of the nozzle 1323 according to the embodiment shown in FIG. 3 and thus, detailed descriptions thereof are omitted.

The waste nutrient solution supply pipe 1325 is placed in the sterilization treatment space 3322 and supplies the waste nutrient solution to be sterilized, into the sterilization treatment space 3322. The waste nutrient solution supply pipe 1325 extends from the ceiling of the sterilization treatment space 3322 downwards. The upper end of the waste nutrient solution supply pipe 1325 communicates with the waste nutrient solution discharge pipe 1170 with the pre-treatment filter 1330 therebetween. The detailed configuration and operation of the waste nutrient solution supply pipe 1325 are the same as those of the waste nutrient solution supply pipe 1325 according to the embodiment shown in FIG. 3 and thus, detailed descriptions thereof are omitted.

The waste nutrient solution L3, which is stored in the sterilization treatment space 3322 and sterilized, is discharged to the outside through the connection pipe 3360 by means of an operation of the nutrient solution discharge pump 1370.

The pre-treatment filter 1330 is installed between the waste nutrient solution discharge pipe 1170 and the waste nutrient solution supply pipe 1325 and allows the waste nutrient solution discharge pipe 1170 and the waste nutrient solution supply pipe 1325 to communicate with each other. The pre-treatment filter 1330 filters foreign substances from the waste nutrient solution introduced into the waste nutrient solution supply pipe 1325 from the waste nutrient solution discharge pipe 1170, thereby performing pre-treatment. The configuration and operation of the pre-treatment filter 1330 are roughly the same as those of the pre-treatment filter 1330 according to the embodiment shown in FIG. 3.

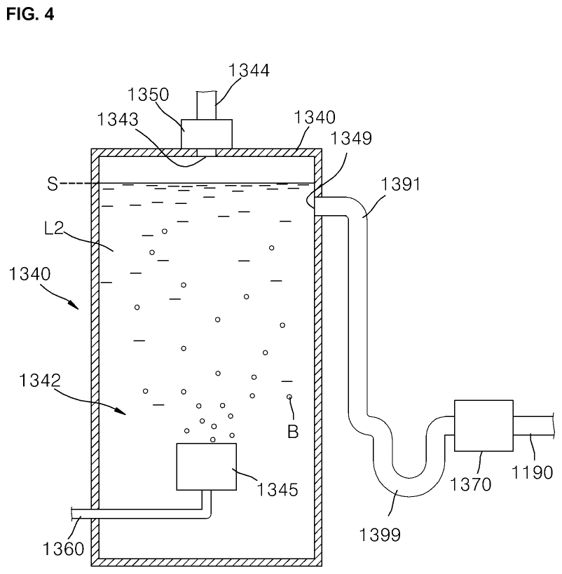

The first gas treatment filter 1350 is installed on the gas discharge pipe 1344. The first gas treatment filter 1350 treats harmful gas components such as ozone (O₃) or chlorine dioxide (ClO₂) included in gas, which is discharged to the outside from the sterilization treatment space 3342 through the gas discharge pipe 1344. The configuration and operation of the first gas treatment filter 1350 are roughly the same as those of the gas treatment filter 1350 according to the embodiment shown in FIG. 4.

The connection pipe 3360 extends from the sterilization treatment unit 3320 and is connected to the nutrient solution discharge pump 1370. One end of the connection pipe 3360 is placed at an upper part of the sterilization treatment space 3322 and is soaked in the waste nutrient solution L3, and the other end of the connection pipe 3360 is connected to the nutrient solution discharge pump 1370. When the nutrient solution discharge pump 1370 operates, the sterilized waste nutrient solution L3 stored in the sterilization treatment space 3322 is discharged through the connection pipe 3360. The connection pipe 3360 includes a U-shaped pipe portion 3361 placed adjacent to the nutrient solution discharge pump 1370. Even when the nutrient solution discharge pump 1370 does not operate, the harmful gas is prevented from passing through the nutrient solution discharge pump 1370 and being discharged through the nutrient solution circulation pipe 1190 by means of the nutrient solution remaining in the U-shaped pipe portion 3361. An additional gas discharge pipe 1395 is connected to a point of the connection pipe 3360 adjacent to the U-shaped pipe portion 3361 at the upstream of the U-shaped pipe portion 3361. The gas that is present in the connection pipe 3360 is discharged to the outside through the additional gas discharge pipe 1395. The connection pipe 3360 further includes a zigzag extension portion 3363 in which the upstream section of the U-shaped pipe portion 3361 extends in a zigzag form to form a long flow path, as shown in the drawing. Time at which the sterilizing gas in the form of bubbles B can be dissolved while the waste nutrient solution flows along the connection pipe 3360 by means of the zigzag extension portion 3363, increases so that sterilization can be performed on the waste nutrient solution by using the sterilizing gas in the form of bubbles B even in the connection pipe 3360. The zigzag extension portion 3363 includes a rising extension portion 3365 that extends upwards from the upstream to the downstream. A bubble reduction unit 3380 is installed on the rising extension portion 3365.

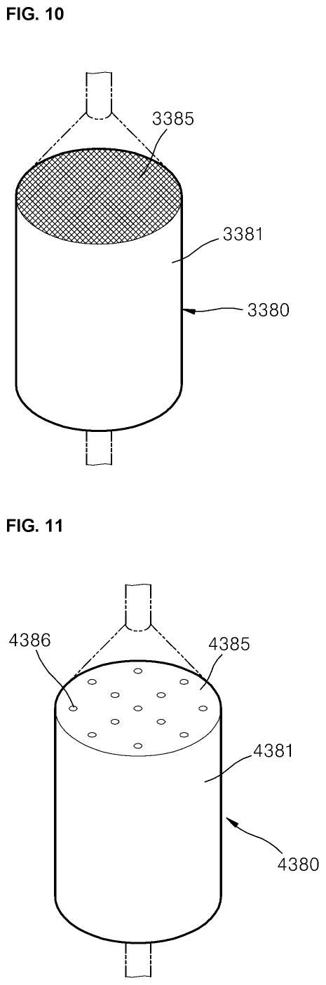

The bubble reduction unit 3380 is installed on the rising extension portion 3365 of the connection pipe 3360 to reduce the size of bubbles flowing together with the nutrient solution so that dissolving can be easily performed. FIG. 9 is a perspective view of the bubble reduction unit 3380. Referring to FIG. 10, the bubble reduction unit 3380 includes a body portion 3381, and a discharge portion 3385 coupled to the body portion 3381.

The body portion 3381 provides an inner space, and a lower portion and sides of the body portion 3381 are closed, and at least a part of an upper end of the body portion 3381 is open so that an opening can be formed in the upper end of the body portion 3381. The waste nutrient solution is introduced into the inner space of the body portion 3381. The inner space of the body portion 3381 forms a passage that is wider than the rising extension portion 3365. The discharge portion 3385 is coupled to the opening formed in the upper end of the body portion 3381.

The discharge portion 3385 is a mesh coupled to the opening formed in the upper end of the body portion 3381. The sterilizing gas in the form of bubbles are broken by the mesh while passing through the discharge portion 3385 so that the size of the sterilizing gas in the form of bubbles is reduced.

In the embodiment of FIG. 10, the discharge portion 3385 is a mesh. However, unlike this, as shown in FIG. 11, a discharge portion 4385 may be a plate having a plurality of fine holes 4386 formed therein. The discharge portion 4385 may discharge the sterilizing gas in the form of bubbles B by reducing the size of the sterilizing gas in the form of bubbles, as in the discharge portion 3385 shown in FIG. 10.

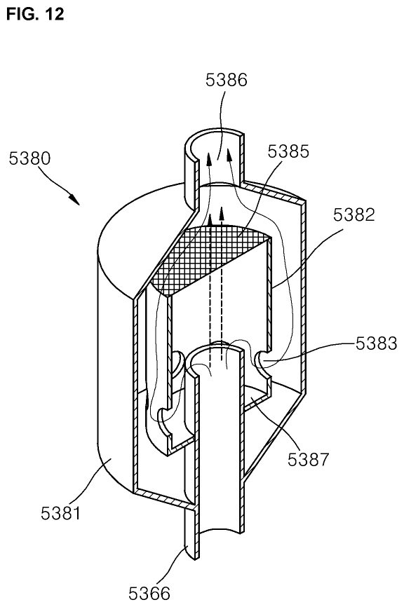

FIG. 12 is a cross-sectional view of a bubble reduction unit according to another embodiment. Referring to FIG. 12, a bubble reduction unit 5380 includes an outer body portion 5381 and an inner body portion 5382. A first inner space 5384 in which the inner body portion 5382 is accommodated, is formed inside the outer body portion 5381. An outlet 5386 is formed at an upper end of the outer body portion 5381. The inner body portion 5382 is accommodated and placed in the first inner space 5384. A second inner space 5387 into which the waste nutrient solution is introduced, is formed inside the inner body portion 5382. A passage portion 5383 is formed on the side of the body portion 5382, and a discharge portion 5385 is formed at an upper end of the body portion 5382. The waste nutrient solution of the second inner space 5387 is discharged to the outside of the second inner space 5387 through the passage portion 5383 and is finally discharged through the outlet 5386. Preferably, the passage portion 5383 is formed to be lower than the end of an introduction pipe 3366 through which the waste nutrient solution is introduced into the second inner space 5387. The discharge portion 5385 formed on the upper end of the body portion 5382 is a mesh, and the sterilizing gas in the form of bubbles contained in the waste nutrient solution are broken by the mesh while passing through the discharge portion 5385 so that the size of the sterilizing gas in the form of bubbles is reduced. Although not shown, the discharge portion 5385 may be a plate having a plurality of fine holes 4386 formed therein, as shown in FIG. 11, and this also belongs to the scope of the present invention.

The configuration of the bubble reduction unit 5380 shown in FIG. 12 may also be used as the waste nutrient solution supply unit 1345 shown in FIG. 4, and this also belongs to the scope of the present invention.

The second gas treatment filter 3390 is installed on the additional gas discharge pipe 1395. The second gas treatment filter 3390 treats harmful gas components such as ozone (O₃) or chlorine dioxide (ClO₂) included in gas, which is discharged to the outside from the connection pipe 3360 through the additional gas discharge pipe 1395. The configuration and operation of the second gas treatment filter 3390 are roughly the same as those of the first gas treatment filter 1350. In the present embodiment, all of the first gas treatment filter 1350 and the second gas treatment filter 3390 are provided, but unlike this, only one of the first gas treatment filter 1350 and the second gas treatment filter 3390 may be provided, and this also belongs to the scope of the invention.

The nutrient solution discharge pump 1370 discharges the waste nutrient solution sterilized by the sterilizing unit 3300a as a reuse nutrient solution. The nutrient solution discharge pump 1370 is installed between the connection pipe 3360 and the nutrient solution circulation pipe 1190 and supplies the sterilized waste nutrient solution, discharged from the sterilizing unit 3300a, as a reuse nutrient solution to the nutrient solution tank (1200 of FIG. 1) or the nutrient solution addition mixing tank (1250 of FIG. 7).

In the medium cultivation system shown in FIGS. 1 and 7, it has been described that an apparatus for sterilizing a nutrient solution sterilizes a waste nutrient solution so as to reuse the waste nutrient solution or to dispose the waste nutrient solution. However, the present invention is not limited thereto. The apparatus for sterilizing the nutrient solution according to the present invention can be used for the purpose of sterilizing the nutrient solution supplied to a cultivation bed, and this also belongs to the scope of the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for sterilizing a nutrient solution to be treated, the apparatus comprising:
a sterilizing unit, which sterilizes the nutrient solution to be treated, by supplying a sterilizing gas in a form of bubbles to the nutrient solution to be dissolved therein; and
a sterilizing gas generator, which generates the sterilizing gas.

2. The apparatus of claim 1, wherein the sterilizing unit comprises a first sterilization treatment unit that performs primary sterilization treatment on the nutrient solution to be treated, and a second sterilization treatment unit that performs secondary sterilization treatment on the primarily-treated nutrient solution discharged from the first sterilization treatment unit, and
the first sterilization treatment unit comprises a first sterilizing tank that provides a first sterilization treatment space in which the nutrient solution to be treated is stored, and a nozzle that supplies the sterilizing gas in a form of bubbles to the nutrient solution to be treated in the first sterilization treatment space, and
the second sterilization treatment unit comprises a second sterilizing tank that provides a second sterilization treatment space in which the primarily-treated nutrient solution is stored, and a nutrient solution supply unit that is disposed in the second sterilization treatment space and supplies the primarily-treated nutrient solution including gas bubbles containing the sterilizing gas, and
while the primarily-treated nutrient solution is supplied into the second sterilization treatment space, the first sterilization treatment space is maintained to be fully filled with the nutrient solution to be treated, and
the sterilizing unit further comprises a gas treatment filter that is installed on a gas discharge pipe through which gas in the second sterilization treatment space is discharged, and that treats harmful gas components.

3. The apparatus of claim 1, wherein the sterilizing unit comprises a first sterilization treatment unit that performs primary sterilization treatment on the nutrient solution to be treated, a second sterilization treatment unit that performs secondary sterilization treatment on the primarily-treated nutrient solution discharged from the first sterilization treatment unit, and a treatment nutrient solution discharge pipe through which the secondarily-treated nutrient solution sterilized by the second sterilization treatment unit is discharged, and
the first sterilization treatment unit comprises a first sterilizing tank that provides a first sterilization treatment space in which the nutrient solution to be treated is stored, and a nozzle that supplies the sterilizing gas in a form of bubbles to the nutrient solution to be treated in the first sterilization treatment space, and
the second sterilization treatment unit comprises a second sterilizing tank that provides a second sterilization treatment space in which the primarily-treated nutrient solution is stored, and a nutrient solution supply unit that is disposed in the second sterilization treatment space and supplies the primarily-treated nutrient solution including gas bubbles containing the sterilizing gas, and
the treatment nutrient solution discharge pipe comprises a U-shaped pipe portion, and
discharging of gas through the treatment nutrient solution discharge pipe is prevented by means of the nutrient solution remaining in the U-shaped pipe portion.

4. The apparatus of claim 1, wherein the sterilizing unit comprises a first sterilization treatment unit that performs primary sterilization treatment on the nutrient solution to be treated, and a second sterilization treatment unit that performs secondary sterilization treatment on the primarily-treated nutrient solution discharged from the first sterilization treatment unit, and
the first sterilization treatment unit comprises a first sterilizing tank that provides a first sterilization treatment space in which the nutrient solution to be treated is stored, a waste nutrient solution supply pipe that supplies the nutrient solution to be treated into the first sterilization treatment space, and a nozzle that supplies the sterilizing gas in a form of bubbles to the nutrient solution to be treated in the first sterilization treatment space, and
the second sterilization treatment unit comprises a second sterilizing tank that provides a second sterilization treatment space in which the primarily-treated nutrient solution is stored, and a nutrient solution supply unit that is disposed in the second sterilization treatment space and supplies the primarily-treated nutrient solution including gas bubbles containing the sterilizing gas, and
the waste nutrient solution supply unit extends from the first sterilization treatment space downwards.

5. The apparatus of claim 4, wherein a waste nutrient solution outlet through which the nutrient solution to be treated is discharged into the first sterilization treatment space, is formed in the waste nutrient solution supply pipe, and the waste nutrient solution outlet is placed at a lower side of the waste nutrient solution supply pipe.

6. The apparatus of claim 1, wherein the sterilizing unit comprises a first sterilization treatment unit that performs primary sterilization treatment on the nutrient solution to be treated, and a second sterilization treatment unit that performs secondary sterilization treatment on the primarily-treated nutrient solution discharged from the first sterilization treatment unit, and
the first sterilization treatment unit comprises a first sterilizing tank that provides a first sterilization treatment space in which the nutrient solution to be treated is stored, and a nozzle that supplies the sterilizing gas in a form of bubbles to the nutrient solution to be treated in the first sterilization treatment space, and
the second sterilization treatment unit comprises a second sterilizing tank that provides a second sterilization treatment space in which the primarily-treated nutrient solution is stored, and a nutrient solution supply unit that is disposed in the second sterilization treatment space and supplies the primarily-treated nutrient solution including gas bubbles containing the sterilizing gas, and
the nutrient solution supply unit comprises a discharge portion that discharges the sterilizing gas in the form of bubbles into the second sterilization treatment space by reducing a size of the sterilizing gas in the form of bubbles supplied into the second sterilization treatment space together with the primarily-treated nutrient solution.

7. The apparatus of claim 6, wherein the discharge portion comprises a mesh or a plate having a plurality of fine holes.

8. The apparatus of claim 7, wherein the nutrient solution supply unit further comprises a passage portion, which is placed to be lower than the discharge portion and through which the nutrient solution is discharged.

9. The apparatus of claim 1, wherein the sterilizing unit comprises a first sterilization treatment unit that performs primary sterilization treatment on the nutrient solution to be treated, a second sterilization treatment unit that performs secondary sterilization treatment on the primarily-treated nutrient solution discharged from the first sterilization treatment unit, and a connection pipe connecting the first sterilization treatment unit to the second sterilization treatment unit, and
the first sterilization treatment unit comprises a first sterilizing tank that provides a first sterilization treatment space in which the nutrient solution to be treated is stored, and a nozzle that supplies the sterilizing gas in a form of bubbles to the nutrient solution to be treated in the first sterilization treatment space, and
the second sterilization treatment unit comprises a second sterilizing tank that provides a second sterilization treatment space in which the primarily-treated nutrient solution is stored, and a nutrient solution supply unit that is disposed in the second sterilization treatment space and supplies the primarily-treated nutrient solution including gas bubbles containing the sterilizing gas, and
the connection pipe allows the first sterilization treatment space and the second sterilization treatment space to communicate with each other, and
the primarily-treated nutrient solution is discharged from the first sterilization treatment space through the connection pipe and is introduced into the second sterilization treatment spaced, and the connection pipe extends in a zigzag form.

10. The apparatus of claim 1, wherein the sterilizing unit comprises a first sterilization treatment unit that performs primary sterilization treatment on the nutrient solution to be treated, and a second sterilization treatment unit that performs secondary sterilization treatment on the primarily-treated nutrient solution discharged from the first sterilization treatment unit,
the first sterilization treatment unit comprises a first sterilizing tank that provides a first sterilization treatment space in which the nutrient solution to be treated is stored, and a nozzle that supplies the sterilizing gas in a form of bubbles to the nutrient solution to be treated in the first sterilization treatment space, and
the second sterilization treatment unit comprises a second sterilizing tank that provides a second sterilization treatment space in which the primarily-treated nutrient solution is stored, and a nutrient solution supply unit that is disposed in the second sterilization treatment space and supplies the primarily-treated nutrient solution including gas bubbles containing the sterilizing gas, and
the sterilizing unit further comprises a pre-treatment filter that filters foreign substance from the nutrient solution to be treated supplied into the first sterilization treatment space.

11. The apparatus of claim 1, wherein the sterilizing unit comprises a sterilizing tank that provides a sterilization treatment space in which the nutrient solution to be treated is stored, a nozzle that supplies the sterilizing gas in a form of bubbles to the nutrient solution to be treated in the sterilization treatment space, and a connection pipe that extends from the sterilizing tank, and
the nutrient solution to be treated sterilized in the sterilization treatment space is discharged from the sterilization treatment space through the connection pipe, and
the connection pipe comprises a U-shaped pipe portion, and
discharging of gas through the connection pipe is prevented by means of the nutrient solution remaining in the U-shaped pipe portion.

12. The apparatus of claim 11, wherein the connection pipe further comprises a zigzag extension portion that extends in a zigzag form.

13. The apparatus of claim 1, wherein the sterilizing unit comprises a sterilizing tank that provides a sterilization treatment space in which the nutrient solution to be treated is stored, a waste nutrient solution supply pipe that supplies the nutrient solution to be treated into the sterilization treatment space, and a nozzle that supplies the sterilizing gas in a form of bubbles to the nutrient solution to be treated in the sterilization treatment space,
the waste nutrient solution supply pipe extends from the sterilization treatment space downwards, and
a waste nutrient solution outlet through which the nutrient solution to be treated is discharged into the sterilization treatment space, is formed in the waste nutrient solution supply pipe, and
the waste nutrient solution outlet is placed at a lower side of the waste nutrient solution supply pipe.

14. The apparatus of claim 1, wherein the sterilizing unit comprises a sterilizing tank that provides a sterilization treatment space in which the nutrient solution to be treated is stored, a nozzle that supplies the sterilizing gas in a form of bubbles to the nutrient solution to be treated in the sterilization treatment space, a connection pipe that extends from the sterilizing tank, and a bubble reduction unit that is installed on the connection pipe and reduces a size of the sterilizing gas in the form of bubbles flowing together with the nutrient solution to be treated, and
the connection pipe comprises a rising extension portion, which extends upwards from upstream to downstream and on which the bubble reduction unit is placed, and
the bubble reduction unit comprises an outer body portion that provides a first inner space, and an inner body portion, which is accommodated in the first inner space and has an upper end on which the mesh or the plate is provided and which provides a second inner space into which the nutrient solution to be treated is introduced, and
a passage portion through which the first inner space and the second inner space communicate with each other, is formed at a side of the inner body portion.

15. The apparatus of claim 1, wherein the sterilizing unit comprises a sterilizing tank that provides a sterilization treatment space in which the nutrient solution to be treated is stored, a nozzle that supplies the sterilizing gas in a form of bubbles to the nutrient solution to be treated in the sterilization treatment space, and a gas treatment filter that is installed on a gas discharge pipe through which gas in the sterilization treatment space is discharged, and that treats harmful gas components.

16. A medium cultivation system comprising:
a cultivation bed on which plants are placed and the plants are cultivated by means of a nutrient solution;
a nutrient solution tank in which the nutrient solution supplied to the cultivation bed is stored; and
an apparatus for sterilizing a nutrient solution, the apparatus sterilizing a waste nutrient solution discharged from the cultivation bed for reuse of disposal or sterilizing the nutrient solution stored in the nutrient solution tank for supply to the cultivation bed,
wherein the apparatus for sterilizing the nutrient solution comprises a sterilizing unit, which sterilizes the nutrient solution to be sterilized, by supplying a sterilizing gas in the form of bubbles to the nutrient solution to be dissolved therein, and a sterilizing gas generator, which generates the sterilizing gas.
